(19) United States
(12) Patent Application Publication
(10) Pub. No.: US 2020/0283095 A1
(43) Pub. Date: Sep. 10, 2020

(54) Electronic Cable Puller

(71) Applicant: SRAM, LLC, Chicago, IL (US)

(72) Inventor: GEOFF NICHOLS, SAN LUIS OBISPO, CA (US)

(21) Appl. No.: 16/294,620

(22) Filed: Mar. 6, 2019

(51) Int. Cl. B62M 9/122; G01D 5/14; B62M 25/08; F16C 1/22; F16C 1/16; F16H 57/029; F16H 25/20

(52) U.S. Cl. CPC B62M 9/122; G01D 5/142; B62M 25/08; F16H 2057/02034; F16C 1/16; F16H 57/029; F16H 25/20; F16C 1/223

(57) ABSTRACT

An electronic cable puller for a bicycle includes a housing, a drive supported by the housing, and an adjuster connected to the housing. The drive is powerable by a power source and is configured to pull the shift cable into or allow the shift cable to be pulled out of the electronic cable puller. The adjuster is configured to adjust a length of the shift cable relative to a sheath.

### FIELD OF THE DISCLOSURE

The present disclosure is generally directed to an electronic cable puller for a bicycle.

### DESCRIPTION OF RELATED ART

A traditional bicycle may change between gears by moving a rear derailleur via a shift cable. For example, a shift control attached to handlebars of the bicycle may be actuated by a rider. The shift control may be connected to a gear changer by a shift cable. The shift control pushes or pulls the shift cable and causes the gear changer to change gears.

### SUMMARY

In one example, an electronic cable puller for a bicycle includes a housing, a drive supported by the housing and powerable by a power source, and an adjuster connected to the housing. The drive is configured to pull a shift cable into or allow the shift cable to be pulled out of the electronic cable puller. The adjuster is configured to adjust a length of the shift cable relative to a sheath.

In one example, the device includes a motor and a gearbox connected to the motor.

In one example, the drive further includes an advancement element connected to the gearbox. The motor is configured to rotate the advancement element via the gearbox.

In one example, the electronic cable puller further includes a shift cable and a carriage disposed on the advancement element. The carriage is connected to the shift cable. The motor is configured to translate the carriage relative to the housing via the rotation of the advancement element, such that the shift cable is pulled into the housing or is allowed to be pulled out of the housing based on a direction of the translation.

In one example, the housing includes a base, a first cover attached to the base, and a second cover that is removably attached to the base. The base and the first cover define a first end of the electronic cable puller. The first end of the electronic cable puller is opposite a second end of the cable puller. The second cover abuts or is adjacent to the first cover.

In one example, the adjustor is a barrel adjuster connected to the housing at the second end of the electronic cable puller, the sheath surrounds a portion of the shift cable, and the adjuster is configured to modify a length of the sheath outside of the electronic cable puller.

In one example, the base and the first cover at least partially define a first chamber, and the base and the second cover at least partially define a second chamber. The first chamber is sealed. The motor and the gearbox are disposed within the sealed first chamber. The carriage is disposed within the second chamber. The advancement element extends between the sealed first chamber and the second chamber.

In one example, the carriage includes a body and a wing extending away from the body of the carriage. An outer profile of the wing corresponds to a channel at an inner surface of the housing.

In one example, the shift cable is connected to the carriage offset relative to an axis of rotation of the advancement element.

In one example, the electronic cable puller further includes a controller supported by the housing. The controller is in communication with the power source and the motor. The controller is configured to control the motor.

In one example, the electronic cable puller further includes one or more sensors in communication with the controller. The one or more sensors are configured to determine a position of the carriage. The controller is configured to control the motor based on the determined position of the carriage.

In one example, the one or more sensors include Hall effect sensors configured to determine a rotational position of the motor.

In one example, the power source is external to the electronic cable puller.

In one example, an electronic cable puller for a bicycle includes a housing, a drive supported by the housing, and a shift cable connected to the drive and connectable to a derailleur of the bicycle. The housing includes a base, a first cover, and a second cover removably attached to the base. The base and the first cover at least partially define a first chamber. The first chamber is sealed. The second cover abuts or is adjacent to the first cover. The base and the second cover at least partially define a second chamber. The drive is at least partially disposed within the first chamber. The drive is configured to pull the shift cable into or allow the shift cable to be pulled out of the electronic cable puller, such that a length of the shift cable is outside of the electronic cable puller.

In one example, the drive further includes a motor, a gearbox connected to the motor, and an advancement element connected to the gearbox. The motor is configured to rotate the advancement element via the gearbox. The electronic cable puller further includes an internally threaded member disposed on the advancement element. The shift cable is connected to the internally threaded member. The motor is configured to translate the internally threaded member relative to the housing via the rotation of the advancement element, such that the shift cable is pulled into the housing or is allowed to be pulled out of the housing based on a direction of the translation.

In one example, the housing includes an end plate attached to the second cover and the base. The motor and the gearbox are disposed within the sealed first chamber. The internally threaded member is disposed within the second chamber. The advancement element extends between the sealed first chamber and the second chamber.

In one example, the electronic cable puller further includes a seal supported by the housing and disposed at least partially between the first chamber and the second chamber. The seal is configured to seal the first chamber from the second chamber. The advancement element extends from the first chamber, through the seal, to the second chamber.

In one example, the electronic cable puller further includes a circumferential seal disposed at least partially between the first cover and the base and a potting seal disposed at an entry of a wire into the housing.

In one example, a drive system includes a derailleur, a cable, and an electronic cable puller connected to the derailleur via the cable. The electronic cable puller includes a housing, a drive supported by the housing and connected to the cable, and an adjuster connected to the housing. The drive is configured to pull the cable into the electronic cable puller or allow the cable to be pulled out of the electronic cable puller. The adjuster is configured to adjust a length of the shift cable relative to a sheath.

In one example, the electronic cable puller further includes a lead disposed at a first end of the housing. The lead is in communication with the drive. The adjuster is connected to the housing at a second end of the housing. The second end of the housing is opposite the first end of the housing.

### BRIEF DESCRIPTION OF THE DRAWINGS

Objects, features, and advantages of the present invention will become apparent upon reading the following description in conjunction with the drawing figures, in which:

FIG. 1 is a side view schematic of a bicycle fitted with an electronic cable puller in accordance with the teachings of this disclosure;

FIG. 2a is an isometric view of an electronic cable puller for a bicycle, such as the bicycle of FIG. 1;

FIG. 2b is a side view of the electronic cable puller of FIG. 1;

FIG. 2c is a perspective view of the electronic cable puller of FIGS. 2a and 2b with a portion of the housing removed;

FIG. 2d is a side view of the electronic cable puller of FIGS. 2a and 2b with a portion of the housing removed;

FIG. 3 is a side view of an adjuster of an electronic cable puller, such as the electric cable puller of FIGS. 2a, 2b, 2c, and 2d;

FIG. 4a is a perspective view of a drive system of an electronic cable puller, such as the electric cable puller of FIGS. 2a, 2b, 2c, and 2d;

FIG. 4b is a side view of the drive of FIG. 4a;

FIG. 4c is a cutaway view of the drive of FIGS. 4a and 4b;

FIG. 5 is an expanded view of the drive of FIGS. 4a-4c;

FIG. 6a is a side view of the carriage of the electronic cable puller of FIGS. 2a, 2b, 2c, and 2d;

FIG. 6b is a perspective view of the carriage of FIG. 6a;

FIG. 6c is a front view of the carriage of FIGS. 6a and 6b;

FIG. 7a is a perspective view of a carriage and a housing of the electronic cable puller of FIGS. 2a, 2b, 2c, and 2d;

FIG. 7b is a front view of the carriage and the housing of FIG. 7a;

FIG. 8 is a side view of an advancement element and a carriage of the electronic cable puller of FIGS. 2a, 2b, 2c, and 2d;

FIG. 9a is a perspective view of control electronics of the electronic cable puller of FIGS. 2a, 2b, 2c, and 2d;

FIG. 9b is another perspective view of control electronics of the electronic cable puller of FIGS. 2a, 2b, 2c, and 2d;

FIGS. 10a, 10b, and 10c are cross-sectional views of the electronic cable puller of FIGS. 2a, 2b, 2c, and 2d, with a carriage in different positions, respectively; and

FIG. 11 is a view of a shift control for a bicycle, such as the bicycle of FIG. 1.

### DETAILED DESCRIPTION OF THE DISCLOSURE

With a manual shift control such as a handlebar-mounted shift lever, a gear on a bicycle may be selected. The manual control depends on the user to select the gear and to change gears appropriately. This may result in a sub-optimal gear being selected, or a gear being selected in error. For example, the user may select too high or low of a gear for a given terrain traversed by the bicycle, or the user may maintain a current gear despite a change in terrain. The user may inadvertently or accidentally select a different gear while riding. Mechanical shifting may require a full stroke of the manual control (e.g. the shift lever), and less than a full stroke may result in an incomplete shift. Further, the user must provide the effort for shifting with the manual control. The manual shift control may require a long length of shift cable to be run from the handlebars to the rear derailleur. This length of cable is susceptible to being caught or tangled with other parts of a bicycle, cut, or torn during use.

An electronic cable puller may provide a solution to one or more of the problems described above. The electronic cable puller may be connected to the gear changer and pull the shift cable to select a gear based on input from the shift controller. Because the shift cable may terminate at the electronic cable puller, the shift control may be mounted anywhere on the bike, regardless of a physical routing of the shift cable. For example, the shift control may be mounted in an ergonomic location not possible with manual shift controls. The shorter length of shift cable between the gear changer and cable puller may be less susceptible to being caught, torn, or cut. Additionally or alternatively, the electronic cable puller may change gears more quickly and/or with greater accuracy than with a manual mechanical shift control. For example, a controller may sense a change in terrain and signal the electronic cable puller to change gears without user input.

Previous designs of electronic cable pullers were self-powered, often relying on batteries. The batteries may have a finite charge and need replaced or recharged over a period of use, after which the electronic cable puller is inoperable. Further, previous designs may use a proprietary shift control and lack compatibility with different shift control and bicycle designs. Still further, previous cable pullers may be difficult to install and maintain because the cable pullers lack an adjustment for the shift cable or a sheath of the shift cable. Additionally, set up and maintenance of previous electronic cable pullers may require a user to remove a cover for the entire cable pulling mechanism, thereby increasing a risk of water and debris ingress. User error when replacing the cover may compromise a seal of the cover, increasing the risk of damage to the cable pulling mechanism

The present disclosure provides examples of electronic cable pullers that may be powered by a centralized battery of an electric power assisted bicycle (“e-bike”) and may not be internally powered. The centralized battery of the e-bike may be recharged during use, providing that the electronic cable puller is operable at all times when the e-bike is in use. In some cases, the e-bike may include one or more sensors or controllers. The electronic cable puller may receive signals from the one or more sensors or controllers to trigger the electronic cable puller to change gears. For example, the e-bike may sense a change in terrain or in user power and signal the electronic cable puller to change gears without user input.

Additionally, the electronic cable pullers disclosed herein may include two covers that attach to a common base of a housing. The common housing in conjunction with the two covers may reduce overall part count for the electronic cable pullers disclosed herein. Set up and maintenance of the electronic cable pullers described herein may require removal of one of the covers, beneath which only some of the components of the electronic cable puller may be disposed. For example, set up and maintenance may require removal of one cover shielding internal components of the electronic cable puller that are not sensitive to dirt or water may be disposed. Another cover of the housing may protect water sensitive components such as control circuitry or a drive, and may not need to be removed during set up and maintenance.

Further, the electronic cable pullers disclosed herein may include an adjustment portion. The adjustment portion may include a manual adjuster for the shift cable. The manual adjuster may be disposed on an external surface of the housing and allow for convenient tuning of the electronic cable puller without disassembly.

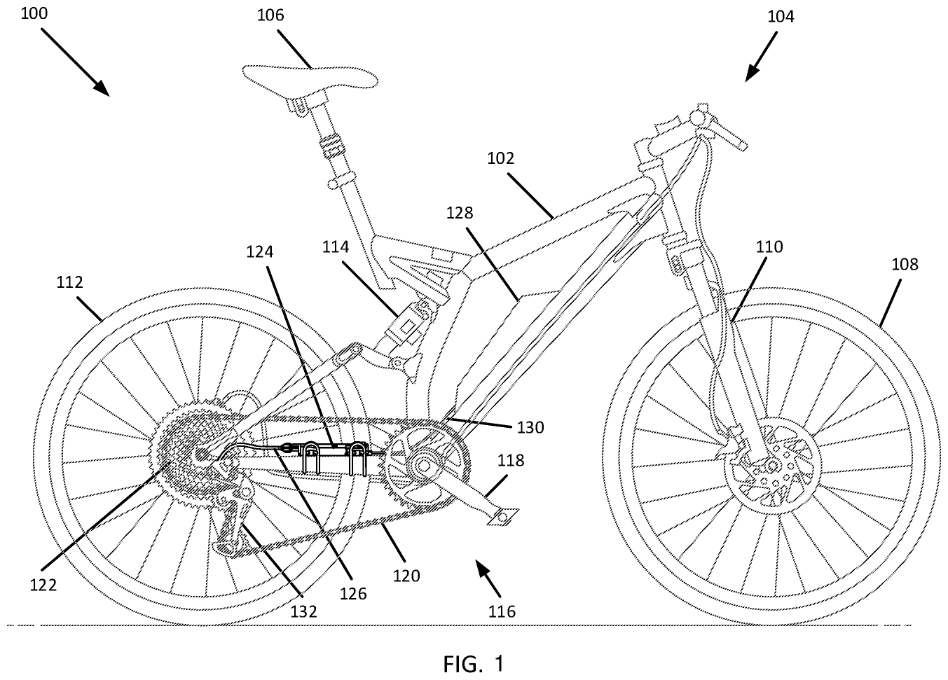

Turning now to the drawings, FIG. 1 generally illustrates one example of a bicycle 100 on which the disclosed electronic cable puller 124 may be implemented. In this example, the bicycle 100 may be a mountain bicycle. In some cases, the bicycle 100 may be an e-bike. The bicycle 100 has a frame 102, handlebars 104 near a front end of the frame 102, and a seat or saddle 106 for supporting a rider over a top of the frame 102. The bicycle 100 also has a first or front wheel 108 carried by a front fork 110 of the frame 102 and supporting the front end of the frame 102. The bicycle 100 also has a second or rear wheel 112 supporting a rear end of the frame 102. The rear end of the frame 102 may be connected to a rear suspension component 114. The bicycle 100 also has a drive train 116 with a crank assembly 118 that is operatively coupled via a chain 120 to a rear cassette 122 near a rotation axis of the rear wheel 112. An electronic cable puller 124 may be mounted to the frame of the bicycle 100. The electronic cable puller 124 may be coupled with a rear derailleur 132 via a shift cable 126 to shift gears on the rear cassette 122. In some cases, the shift cable 126 may be a Bowden cable. In this example, the electronic cable puller 124 may be connected to a controller 128 of the bicycle via a lead or wire 130. In some cases, the controller 128 may include a power source and provide power to the electronic cable puller 124 by the wire 130. In another example, the electronic cable puller 124 may communicate wirelessly with the controller 128.

While the bicycle 100 depicted in FIG. 1 is a mountain bicycle, the electronic cable puller 124, including the specific embodiments and examples disclosed herein as well as alternative embodiments and examples, may be implemented on other types of bicycles. For example, the disclosed electronic cable puller 124 may be used on road bicycles, as well as bicycles with mechanical (e.g., cable, hydraulic, pneumatic, etc.) and non-mechanical (e.g., wired, wireless) drive systems.

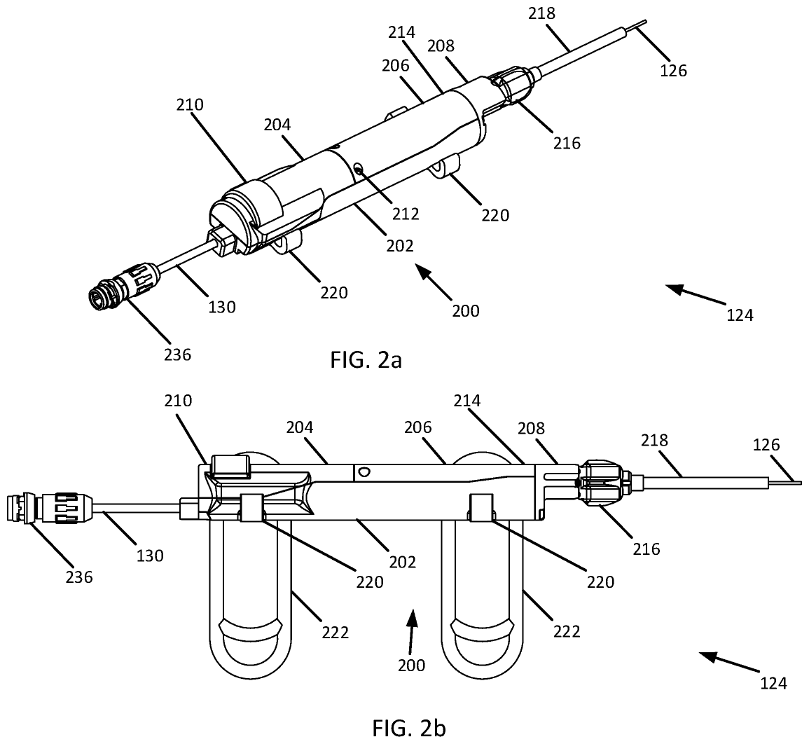

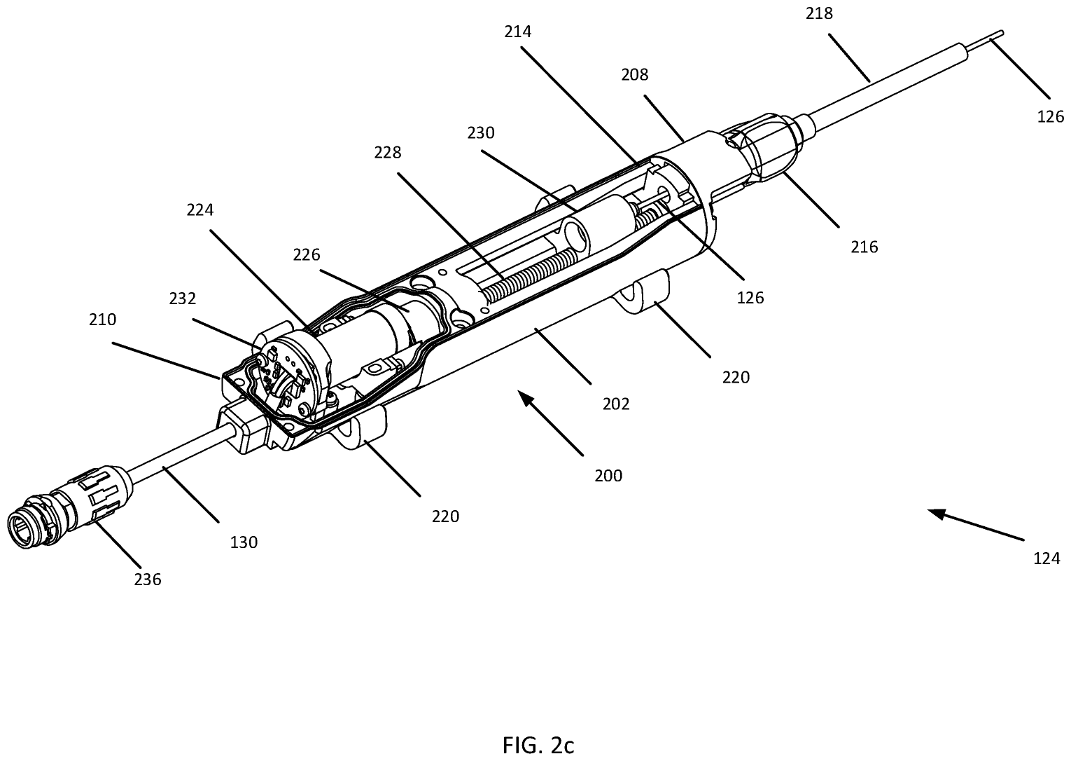

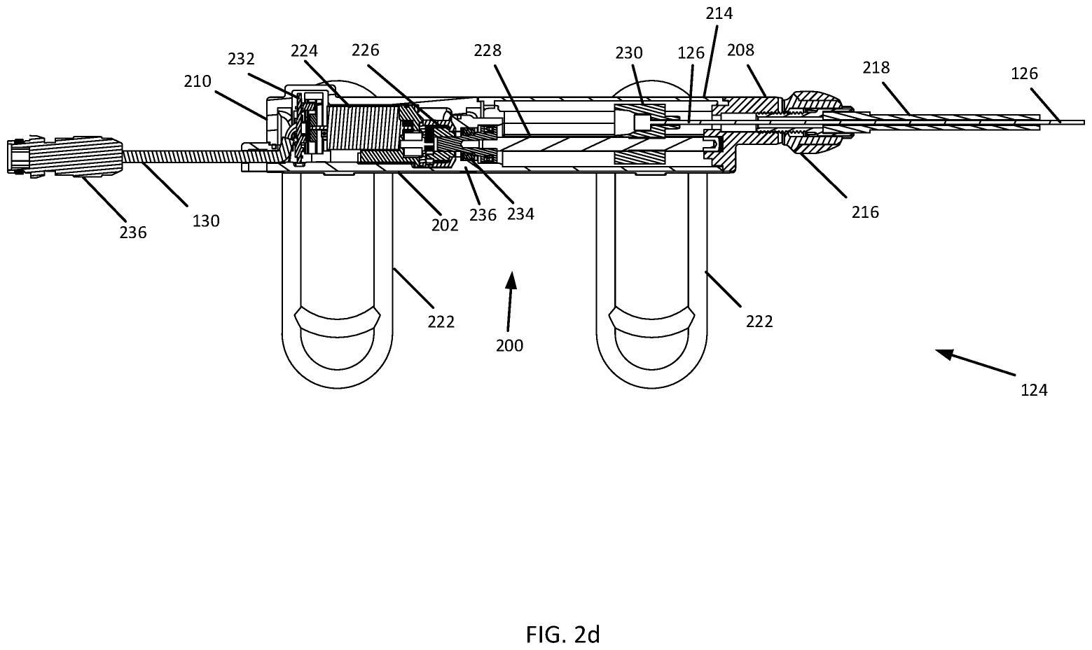

Referring to FIGS. 2a and 2b, the electronic cable puller 124 is shown in greater detail. The electronic cable puller 124 includes a wire 130, which extends through one end (e.g., a first end) of the electronic cable puller 124, and a shift cable 126, which extends through another end (e.g., a second end) of the electronic cable puller 124. One end of the wire 130 may terminate in a connector 236. A portion of the shift cable 126 is surrounded by a sheath 218.

The electronic cable puller 124 has a housing 200 including a base 202, a first cover 204, a second cover 206, and an end plate 208. The first cover 204 is attached to the base 202 in any number of ways including, for example, with one or more connectors (e.g., screws), an adhesive, or a combination thereof. The first cover 204 and/or the base 202 at least partially define the first end 210 of the electronic cable puller 124 and a first chamber (see FIG. 2c) within the electronic cable puller 124. The first cover 204 may be attached to the base 202 in a way that makes it difficult for a user of the electronic cable puller 124 to access the first chamber (e.g., a first portion). The first chamber of the electronic cable puller 124 may also be waterproof, as electrical components of the electronic cable puller 124 may be disposed within the first chamber. For example, a waterproof seal may be disposed between the first cover 204 and the base 202 of the housing 200. The seal may be a circumferential seal between the first cover 204 and the base 202. The waterproofing may prevent the intrusion of water or other liquids beyond the first cover 204 to, for example, protect the electrical components (e.g., control electronics, a motor, and hall effect sensors).

The second cover 206 is attached to the base 202 in any number of ways including, for example, with one or more connectors (e.g., screws 212 into tapped holes in the base 202, bolts, or other tooled or non-tooled fasteners). The second cover 206 and the base 202 at least partially define a second chamber (see FIG. 2c) within the electronic cable puller 124. The second cover 206 may be removably attached to the base 202, such that the user may access the second chamber to install and replace components (e.g., the shift cable 126, a advancement element, and a carriage) within the second chamber of the electronic cable puller 124 and/or for adjustment of one or more of the components within the second chamber of the electronic cable puller 124. The second cover 206 may be dustproof in that the attachment of the second cover 206 to the base 202, combined with the end plate 208, keeps dust out of the second chamber. In one example, a dustproof seal is disposed between the second cover 206 and the base 202 of the housing 200. The dustproof seal may prevent intrusion of dust and debris into the second chamber of the electronic cable puller 124. In some cases, the second chamber is free of electrical components, and thus, the attachment of the second cover 206 to the base 202 may require less extensive sealing against water ingress as compared to the attachment of the first cover 204 to the base 202.

The end plate 208 is attached to the base 202 and/or the second cover 206 in any number of ways. The end plate 208 may removably attached to the base 202 with one or more connectors. For example, one or more screws bolts, or other tooled or non-tooled fasteners may secure the end plate 208 with holes in the base 202. In one example, the end plate 208 abuts or is adjacent to the second cover 206 but is not attached to the second cover 206 with, for example, one or more connectors. One or more intervening parts, such as a seal, may be disposed between the end plate 208 and the second cover 206. The end plate 208 at least partially defines the second end 214 of the electronic cable puller 124. The end plate 208 may be removably attached to the base 202 to allow installation of one or more components within the second chamber of the electronic cable puller 124 (e.g., the lead screw and the carriage).

The electronic cable puller 124 also includes an adjuster 216 at or adjacent to the second end 214 of the electronic cable puller 124. The adjuster 216 may adjust a length of a path that the shift cable 126 traverses to, for example, the rear derailleur 132. The length of the path traversed by the shift cable may be changed by adjusting a length of a sheath 218 outside of the electronic cable puller 124. The sheath 218 surrounds a portion of the shift cable 126. An end of the sheath 218 is positioned within a recessed portion of the adjuster 216. For example, an end of the sheath 218 may abut a ledge inside the recessed portion of the adjuster 216. The adjuster 216 has an opening through which the shift cable 126 extends into the second chamber. In one example, the adjuster 216 is a barrel adjuster. For example, the adjuster 216 may be rotated to increase or decrease a distance between the sheath 218 and the electronic cable puller 124. Because the shift cable 126 is, for example, flexible, increasing the distance between the sheath 218 and the electronic cable puller 124 may lengthen a path for the shift cable 126 to the rear derailleur 132, and thus adjust a position of the rear derailleur relative 132 to the rear cassette 122.

In some cases, the end plate 208 may support the adjuster 216. For example, the adjuster 216 has external or internal threads, and the end plate 208 may have a threaded portion into or onto which the adjuster 216 is rotatably attached. The end plate 208 also includes an opening through which the core the shift cable 126 extends into the second chamber. The end plate 208 may also support an end of the lead screw (see FIGS. 2c and 2d).

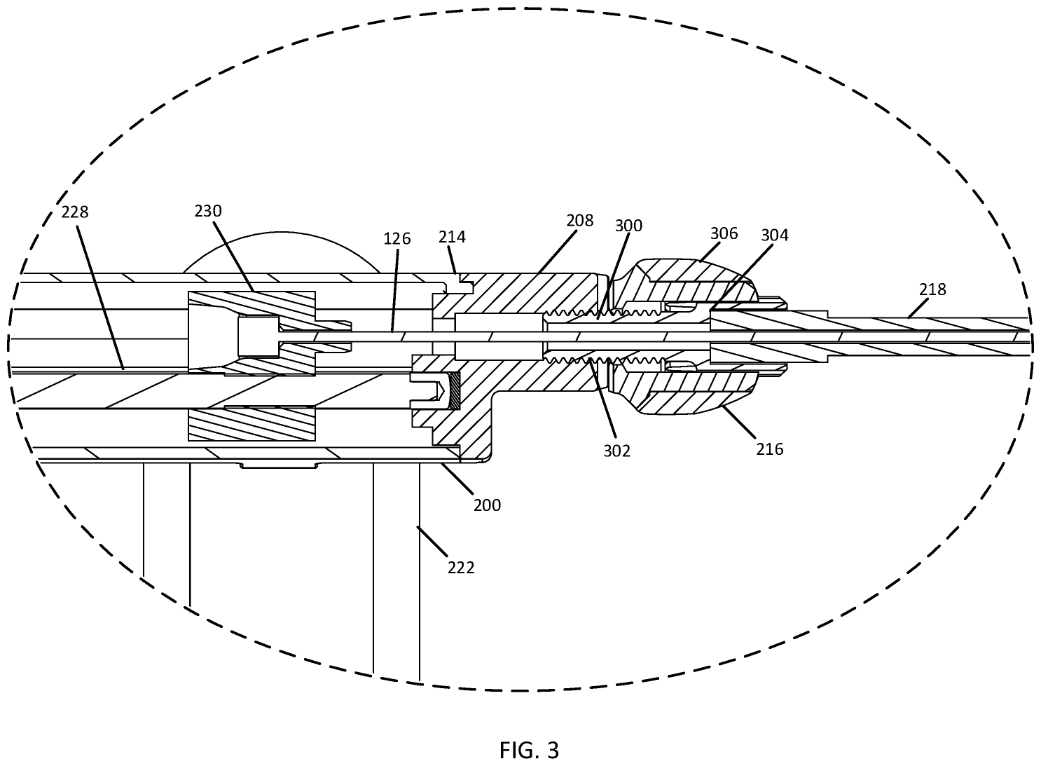

Referring to FIG. 3, the adjuster 216 is shown with a core member 300, attachment element 302, and a support element 304. The core member 300 may be disposed within a housing 306 of the adjuster 216. The core member 300 may extend beyond the housing 306 and into an end plate 208 of the cable puller 124. In some cases, the core member 300 may extend at least partially into the housing 200 of the cable puller 124. The core member 300 may be secured to the end plate by the attachment element 302. The cable 126 may extend through the core member 300.

The attachment element 302 may include threading. The threading may correspond a surface of the end plate 208. Rotation of the adjuster 216 may result in rotation of the attachment element 302. The attachment element 302 may translate with rotation. For example, rotation of the attachment element 302 may cause the attachment element 302 to translate as the threading on the attachment element 302 acts against the end plate 208.

The support element 304 may be disposed on the core member 300 opposite the attachment element 302. The support element 304 may include a surface against which a sheath 218 of the shift cable 126 may rest. The sheath 218 may be supported on one end by the rear derailleur 132 and on the other end by the support element 304. Rotation of the adjuster 216 may increase or decrease a distance between the end of the sheath 218 supported by the support element 304 and the end plate 208 of the cable puller 126.

The housing 306 of the adjuster 216 may be user-accessible. The housing may have a round, square, or other outside profile. For example, the housing 306 may have a substantially circular outer profile like a barrel adjuster. The housing 306 may have a surface treatment. For example, the housing 306 may have ridges or knurling. The surface treatment may increase the grip on the adjuster 216. Rotation of the housing 306 may cause one or more elements of the adjuster 216 to rotate. For example, the core member 300, attachment member 302, and supporting element 304 may rotate along with the housing 306.

Referring to FIGS. 2a and 2b, one or more attachment protrusions 220 may extend from the housing 200. For example, four attachment protrusions 220 extend away from the housing 200, with two attachment protrusions 220 extending away from each of opposite sides of the base 202. More or fewer attachment protrusions 220 may extend away from the housing 200. The attachment protrusions 220 may be positioned anywhere on an outer surface of the housing 200. The attachment protrusions 220 may allow for installation of the electronic cable puller 124 on a bicycle (e.g., the bicycle 100 of FIG. 1). Referring to FIG. 2b, the attachment protrusions 220 may be shaped to receive portions of mounting elements 222 (e.g., elastic bands), respectively. For example, the attachment protrusions 220 may be hook-shaped. The attachment protrusions 220 may be the same or differently shaped. The mounting elements 222 may, for example, extend around a mounting portion of a bicycle and be held in place or secured by the attachment protrusions 220, respectively, on the opposite sides of the base 202, such that the electronic cable puller 124 is secured to the mounting portion of the bicycle. The mounting portion of the bicycle may be a portion of the frame 102 of the bicycle 100. One or more mounting elements 222 may be used to secure electronic cable puller 124 to the bicycle. The number of mounting elements 222 used may be determined by the number of pairs of attachment protrusions 220 extending away from the housing 200.

The mounting elements 222 allow the electronic cable puller 124 to be secured to any number of different parts of, for example, the bicycle 100, including chainstays, seatstays, down tubes, and seat tubes. In this way, the electronic cable puller 124 may not be dependent on a specific geometry of the bicycle 100, which may be highly variable based on style, application, and sizing, but may instead be part of a standardized mounting geometry that may be implemented across multiple bicycle manufacturers (e.g., including multiple e-bike motors and batteries). Additionally or alternatively, the electronic cable puller 124 may be secured to the e-bike controller 128.

The mounting elements 222 may be elastic to provide tension when stretched. For example, the mounting elements 222 may be made from natural or synthetic rubber or another material with elastic properties. The mounting elements 222 may be removably attached to the attachment protrusions 220, respectively. For example, the mounting elements 222 may be separated from the attachment protrusions prior to installation of the electronic cable puller 124 on the bicycle 100. When the electronic cable puller 124 is located or placed on the bicycle 100, the mounting elements 222 may be routed around the bicycle 100 such that a portion of the bicycle 100 extends in a space between the housing 200 of the electronic cable puller 124 and the mounting elements 222. The mounting elements 222 may be joined to the attachment protrusions 220 to secure the electronic cable puller 124 to the bicycle 100. Additionally or alternatively, the mounting elements 222 may be joined with attachment protrusions 220 located on the bicycle 100 to secure the electronic cable puller 124 to the bicycle 100.

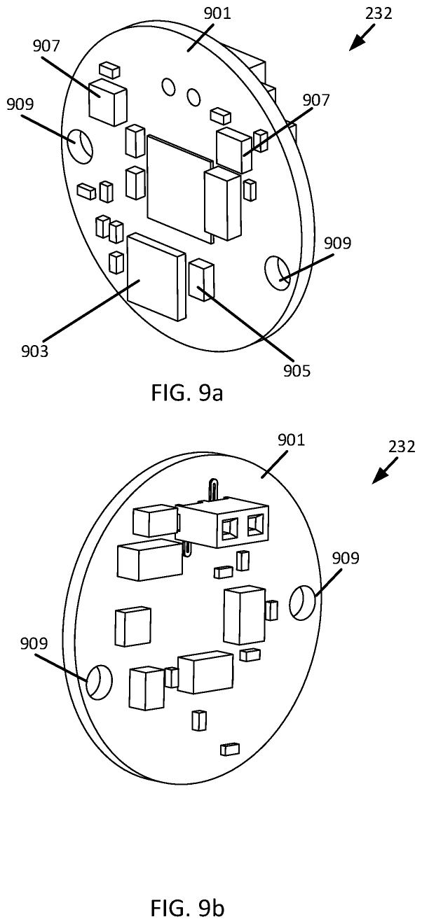

FIGS. 2c and 2d show an electronic cable puller for a bicycle, such as the bicycle of FIG. 1, with a portion of the housing 200 (e.g., the first cover 204 and the second cover 206) removed. The electronic cable puller 124 may include a motor 224 connected to a gearbox 226 to drive a movement of a carriage 230. In some cases, the motor 224 and gearbox 226 drive the carriage 230 by rotating an advancement element 228. The advancement element 228 may be a threaded rod. The carriage 230 may be a nut, such as a lead nut. The motor 224 may be controlled by control circuitry 232 disposed on a substrate 901 (see FIGS. 9a and 9b).

In one embodiment, the assembly of the motor 224, the gearbox 226, the advancement element 228, the carriage 230, and the control circuitry 232 within the electronic cable puller 124 may be organized linearly. For example, starting from the first end 210 of the electronic cable puller 124, the wire 130 extends through the first end 210 of the electronic cable puller 124 and connects to the control circuitry 232 (e.g., including a printed circuit board (PCB) and one or more processors). The control circuitry 232 is electrically connected (e.g., with wires or wirelessly) to the motor 224, which is connected to the gearbox 226. The control circuitry 232 may be arranged perpendicular to a main axis of the electronic cable puller 124 defined by the motor 224, the gearbox 226, the advancement element 228, and the carriage 230, or any combination thereof. The gearbox 226 drives rotation of the advancement element 228, which translates the carriage 230. The shift cable 126 is connected to the carriage 230 and extends through the adjuster 216, out of the second end 214 of the electronic cable puller 124. In some cases, the sheath 218 surrounding the shift cable 126 may terminate at the adjuster 216. The control circuitry 232, the motor 224, and the gearbox 226 are positioned within the first chamber defined by the housing 200, and the carriage 230 is positioned within the second chamber defined by the housing 200. The advancement element 228 extends between the first chamber and the second chamber. Other configurations and/or positioning may be provided.

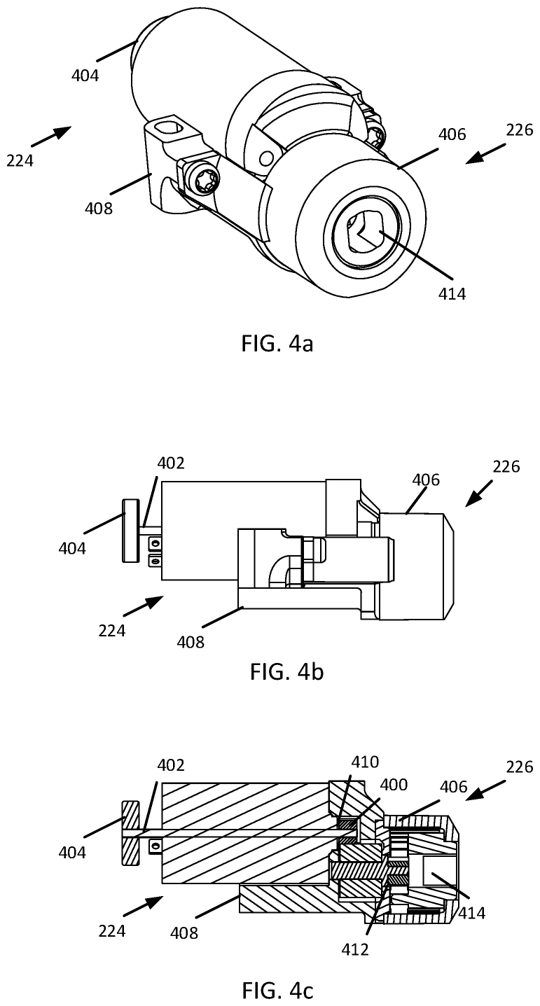

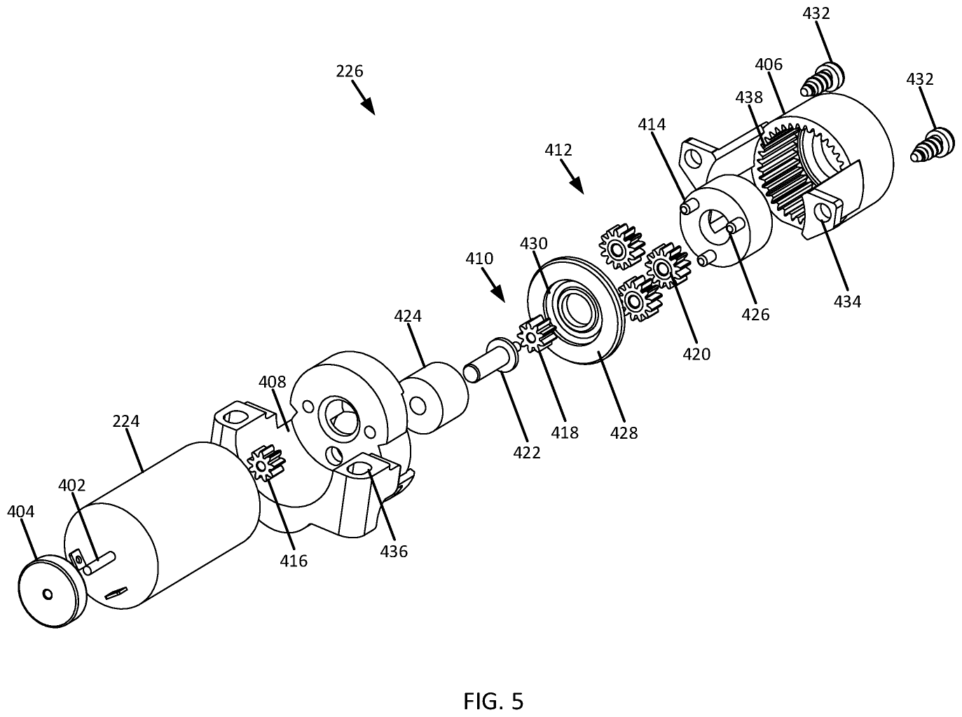

The motor 224 may be an electromotive device. For example, the motor 224 may be an electric motor. The motor includes one or more output shafts (e.g., two output shafts). Referring to FIGS. 4a-4c and 5, a first output shaft 400 of the motor 224 may drive the gearbox 226. In some cases, a drive gear 416 disposed on the output shaft 400 may drive the gearbox 226. A second output shaft 402 of the motor 224 may protrude from a side of the motor 224 opposite the first output shaft 400. The second output shaft 402 may be connected to a rotary position sensor 404. The rotary position sensor 404 may include one or more feedback magnets. The second output shaft 402 may be common with the first output shaft 400 such that a feedback magnet of a rotary position sensor 404 turns with rotation of the first output shaft 400. The feedback magnet 404 may be used by the control circuitry 232 to determine a position or other information about the motor 224 or other components of the electronic cable puller 124. In some cases, the motor 224 may be located in a portion of the housing 200 that is waterproofed or otherwise sealed against the ingress of water or other liquids (e.g., the first sealed chamber of the housing 200).

Referring to FIGS. 2c and 2d, the gearbox 226 may be driven by the motor 224. For example, rotation of the first output shaft 400 of the motor 224 may drive the gearbox 226. In some cases, the gearbox 226 may be a hybrid two-stage spur and planetary gearbox. For example, a first stage of the two-stage gearbox 226 may be a spur gear, and a second stage of the two-stage gearbox 226 may be a planetary gear. An output of the gearbox 226 may be a low backlash interface. In some cases, the gearbox 226 may be located in a portion of the housing 200 that is waterproofed.

In some cases, all or portions of the motor 224 and the gearbox 226 may be combined in a common motor gearbox assembly. In such cases, a motor block may provide support for one or more components of the motor 224 and the gearbox 226. The motor block may, for example, form an enclosure for the first stage of the gearbox 226. A ring gear may, for example, form the enclosure for the second stage. The gearbox 226 and/or the common motor gearbox assembly, including the motor block, may be located in the waterproof chamber of the housing 200 (e.g., the first sealed chamber of the housing 200).

Referring to FIGS. 4a-4c and 5, the gearbox 226 may include a ring gear housing 406. The motor 224 and the gearbox 226 may be supported by a common motor block 408. A first spur stage 410 and a second planetary stage 412 of the gearbox 226 may be under the ring gear housing 406. The gearbox 226 may drive an output interface 414. The ring gear housing 406 may mount to the common motor block 408. The ring gear housing 406 may enclose the second planetary stage 412 of the gearbox 226.

The spur stage 410 may include a spur gear 418. The spur gear 418 may drive one or more planetary gears 420 of the planetary stage 412 of the gearbox 226. The spur gear 418 may be disposed on a supporting member 422. The supporting member 422 may be supported on one end by the motor block 408. In some cases, a cover 424 may be placed over the spur gear and/or the supporting member 422.

The planetary stage 412 may include one or more planetary gears 420. The planetary gears 420 may be supported by the output interface 414. For example, the output interface may have one or more spindles 426 that support the planetary gears 420. The planetary stage 412 may include a cover 428 with a recess 430 and may be disposed opposite the backlash interface 414. The cover 428 may retain the planetary gears 420 on the spindles 426. The planetary gears 420 may drive the output interface 414.

The common motor block 408 may support both the motor 224 and the gearbox 226. Additionally or alternatively, the motor block 408 may support the ring gear housing 406. For example, fasteners 432 may secure the ring gear housing 406 to the motor block 408 via mounting holes 434. In some cases, the motor 224 and gearbox 226 may be installed in the common motor block 408 to form an assembly. The assembly may be then installed into the housing 200 of the electronic cable puller 124. The motor block 408 may be secured to the housing 200 by one or more fasteners. For example, the fasteners may secure the motor block 408 to the housing 200 via mounting holes 436.

The ring gear housing 406 may have a toothed inner surface 438. A profile of the toothed inner surface 438 may correspond to an outer profile of one or more of the planetary gears 420 of the of the planetary stage 412 of the gearbox 226.

The output interface 414 may be a low backlash output interface for driving the advancement element 228. In some cases, the output interface 414 may support one or more planetary gears 420 of the planetary stage 412 of the gearbox 226. For example, the output interface 414 may act as a carrier that supports the planetary gears 420 on the spindles 426 extending from the output interface 414. The output interface 414 may be shaped to correspond to a shape of the advancement element 228. In some cases, the output interface 414 extends within a portion of the housing 200 having the motor 224 and gearbox 226. For example, the output interface 414 may extend within the waterproofed or sealed portion of the housing 200 (e.g., the first sealed chamber of the housing 200). In other cases, the output interface 414 may extend into a second portion of the housing 200 (e.g., the second chamber of the housing 200). For example, the output interface 414 may extend from the sealed portion of the housing 200 into the user-accessible portion of the housing 200.

Referring to FIGS. 2c and 2d, the advancement element 228 may be rotated by the output of the gearbox 226 (e.g., the output interface 414). The advancement element 228 may be a lead screw with threading on an outer surface of the lead screw. The advancement element 228 may be supported on one or more ends by the housing 200. The advancement element 228 supports the carriage 230. At least a portion of the advancement element 228 is located in a user-accessible portion of the housing 200. In the case that the gearbox is located in the waterproofed portion of the housing 200, a portion of the advancement element 228 may extend from the waterproof portion of the housing 200 to another portion of the housing 200. The advancement element 228 may pass through a rotating seal. In other cases, a portion of the gearbox 226 may extend out of the waterproof portion of the housing 200 and drive the advancement element 228. The advancement element 228 may connect to the gearbox 226 with a low-backlash interface.

In one embodiment, the carriage 230 may be disposed on the advancement element 228. The carriage 230 has an opening (e.g., a first opening) through which the advancement element 228 extends. The opening is, for example, threaded on an inner surface. The threading may match the threading on, for example, the outer surface of the advancement element 228. Rotation of the advancement element 228 causes the carriage 230 to translate along a length of the advancement element 28, and thus, along a length of the housing 200. The carriage 230 may have a second opening for retaining an end of the shift cable 126. The shift cable 126 may extend through the second opening. A fixing bolt on an end of the shift cable 126 may secure the shift cable to the carriage 230. The carriage 230 and the advancement element 228 together may form a non-backdriveable pair. For example, force applied by the shift cable 126 may not significantly move the carriage 230 combined with the advancement element 228.

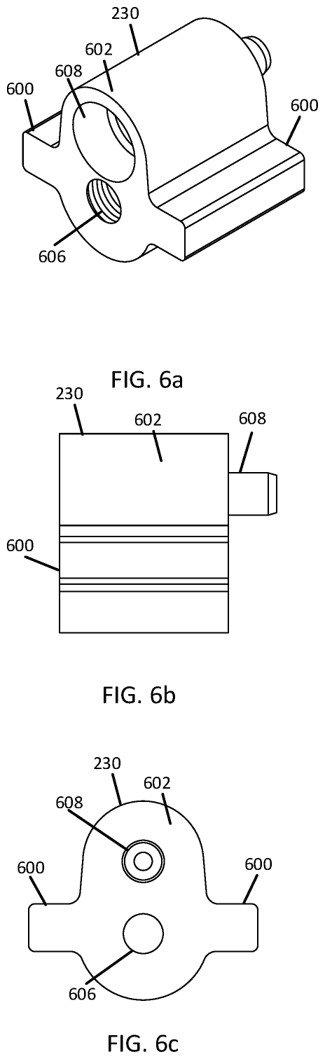

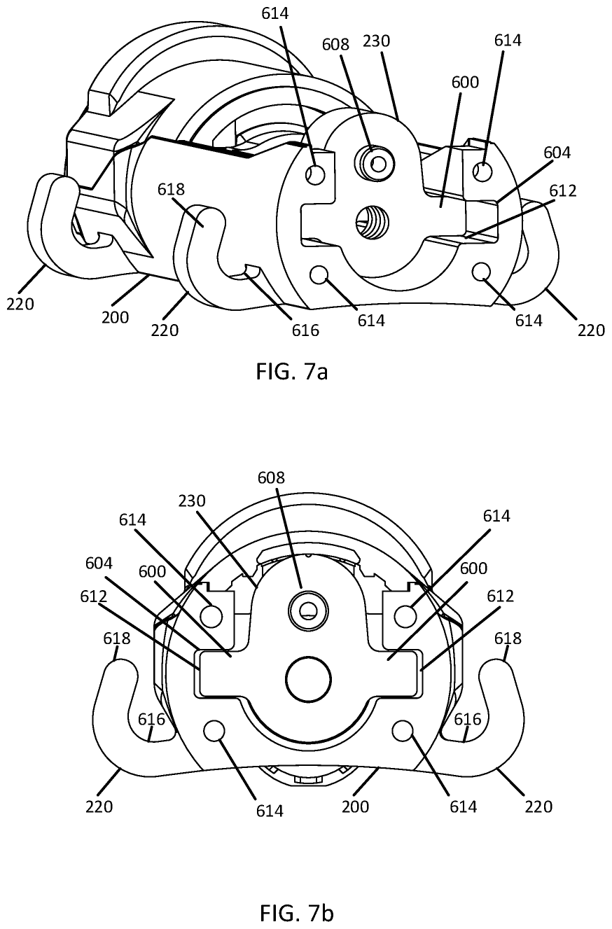

In some cases, the carriage 230 may have one or more wings extending from a body of the carriage 230. Referring to FIGS. 6a-6c and 7a-7b, the carriage 230 may include, for example, two wings 600 extending away from opposite sides of a body 602 the carriage 230. The carriage 230 may include more or fewer wings 600 extending away from the body 602 of the carriage 230. The wings 600 may fit inside corresponding channels 604 in the housing 200 extending essentially parallel to an extent of the advancement element 228. In some cases, the shift cable 126 and the advancement element 228 may not be colinear. As the carriage 230 translates along the advancement element 228 and pulls the cable 126b, a distance between the advancement element 228 and the cable 126b may cause a rotational force or torque to act upon the carriage 230. The wings 600 may limit an amount of rotation possible by the carriage 230 and keep the carriage 230 aligned with respect to the advancement element 228. Excess rotation may cause the electronic cable puller 124 to bind or cause excess wear on components such as the advancement element 228, the carriage 230, and the shift cable 126.

The second opening 608 may extend partially or entirely through a body of the carriage 230. In one example, the second opening 608 extends partially or entirely through one of the wings 600. The shift cable 126 may be fed through the second opening 608. For example, the shift cable 126 without the sheath 218 may be fed through the second opening 608. A fixing bolt 610 may be installed on an end of the shift cable 126. The fixing bolt 610 may prevent the shift cable 126b from being pulled back through the second opening 608 and the carriage 230. In one example, the second opening 608 includes different portions with different diameters such that a flange, on which the fixing bolt 610 may be positioned, is formed. In such an example, the fixing bolt 610 may be attached to the carriage 230 with a friction fit. In one example, the fixing bolt 610 is able to move (e.g., rotate) within the second opening 608 (e.g., on the flange).

The first opening 606 may extend partially or entirely through the body 602 of the carriage 230. In one example, the first opening 606 extends through a center of the body 602 of the carriage 230. The carriage 230 may ride on the advancement element 228 with the advancement element 228 extending through the opening 606. A surface of the first opening 606 may be threaded. For example, the threading of the first opening 606 may correspond to threads on a surface of the advancement element 228. Rotation of the advancement element 228 causes the carriage 230 to translate along a length of the advancement element 228. In some cases, a surface at least partially forming the second opening 608 is parallel to an axis of rotation of the carriage 230 through the center of the carriage 230. A centerline of the second opening 608 may be offset from the axis of rotation of the carriage 230 in a direction away from the wings 600 (e.g., directly above or below the axis of rotation of the carriage 230).

The one or more wings 600 may extend away from the body 602 of the carriage 230. The wings may extend for a portion of or all of the length of the carriage 230. In the case that the advancement element 228 and the shift cable 126 are not co-axial, the carriage 230 may rotate along an axis perpendicular to the advancement element 228 or the shift cable 126. In the case that there is friction between the second opening 608 and the advancement element 228, the carriage 230 may rotate along an axis essentially parallel to the advancement element 228 or the shift cable 126. Positioning of the wings 600 within the channels 604 may prevent rotation of the carriage 230 as the carriage 230 traverses along the advancement element 228.

Referring to FIGS. 7a and 7b, the wings 600 of the carriage 230 ride in channels 604 on an interior of the housing 200 (shown with the attachment protrusions 220 and mounting holes 614). The channels 604 may be recesses or slots formed into an interior portion of the housing 200. The number of channels 604 may correspond to the number of wings 600 extending away from the body 602 of the carriage 230. The channels 604 may have a profile corresponding to a profile of the wings 600, in that a size and/or a shape of each of the channels 604 may correspond to a size and/or a shape of the wing 600 positioned within the respective channel 604. For example, the wings 600 may fit inside the channels 604 with small gaps 612 between the wings 600 and the channels 604. A profile of the wings 600 may be shaped to match a profile of the channels 604 to minimize the size of the gaps 612 The wings 600 may ride in the channels 604 to resist a rotation caused by a load on the carriage 230 applied by the shift cable 126 and the advancement element 228. The channels 604 may extend along all or part of a length of the housing 200. For example, one or more channels 604 may extend along a length of a user-accessible or dustproof portion of the housing (e.g. within the second chamber of the housing 200). In some cases, the channels 604 may extend into the end plate 208.

The attachment protrusions 220 may include a supporting portion 616 and a retaining portion 618. When the mounting elements 222 are placed on the attachment protrusions 220, the supporting portion 616 may support one or more mounting elements 222. The retaining portion 618 may prevent the mounting elements 22 from slipping off of the supporting portion 616.

The mounting holes 614 may support the end plate 208. For example, the end plate 208 may be secured to the housing 200 by one or more fasteners. The fasteners may fit into the mounting holes 614 to secure the end plate 208.

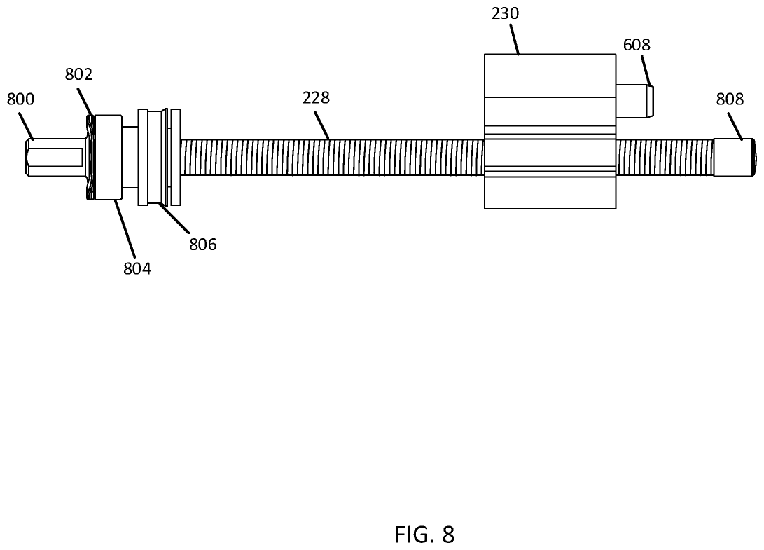

FIG. 8 shows a side view of an example of a carriage (e.g., the carriage 230) positioned on an advancement element (e.g., the advancement element 228). The advancement element 228 may be connected to a low backlash interface 800, a biasing device 802, a first bearing 804, a rotary seal 806, and a second bearing 808.

The low backlash interface 800 may couple the advancement element to the gearbox 226. For example, a profile of the low backlash interface 800 may correspond to a profile of the output of the gearbox 226. The profile of the low backlash interface 800 may be configured to reduce or eliminate backlash between the gearbox 226. For example, the profile of the low backlash interface 800 may be configured to closely match a profile of the gearbox 226. In some cases, the low backlash interface 800 may extend to a sealed or waterproofed portion of the housing 200 where the gearbox 226 is disposed (e.g., the first chamber of the housing 200).

The biasing device 802 may act against an inner surface of the housing 200. In some cases, the biasing device 802 may act between an inner surface of the housing 200 and the first bearing 804. In this way, the biasing device may apply a force that deflects the advancement element 228 in a direction away from the gearbox 226. The biasing device 802 may be a preloading spring.

The first bearing 804 may be a radial bearing. The first bearing 804 supports the advancement element 228 and is supported by the housing 200. For example, the first bearing 804 may be supported by an interior extent of the user-accessible or dust-proof portion of the housing 200 (e.g., within the second chamber of the housing 200). In addition or alternatively, the first bearing 804 may be disposed in and supported by an interior extent of the waterproof or sealed portion of the housing 200 (e.g., within the first chamber of the housing 200).

The rotary seal 806 may be disposed on the advancement element 228. The rotary seal 806 may seal one portion of the housing from another portion of the housing 200. For example, the rotary seal 806 may separate a waterproof or sealed portion of the housing 200 from the user-accessible or dust proof portion of the housing 200 (e.g., the first sealed chamber of the housing 200 from the second chamber of the housing 200). The rotary seal 806 may be supported by a passage 236 between the waterproof or sealed chamber of the housing 200 and the user-accessible or dust proof portion of the housing 200. In some cases, the rotary seal 806 may form all or part of a rotary seal 234 shown in FIG. 2d.

The second bearing 808 may be a radial and thrust bearing. The second bearing 808 may be supported by the housing 200. For example, the second bearing 808 may be disposed within a user-accessible or dustproof portion of the housing 200 (e.g., within the second chamber of the housing 200) and supported by an interior extent of the portion of the housing 200.

Referring to FIGS. 2c and 2d, the shift cable 126 may be installed in the electronic cable puller 124 by removing the second cover 206. Based on instructions from, for example, the controller 128, the control circuitry 232 may cause the motor 224, gearbox 226, and advancement element 228 to rotate until the carriage 230 translates to an end of the housing 200 (e.g., the second end 214 of the housing 200) corresponding to the rear derailleur 132 selecting the most outboard gear of the rear cassette 122. If replacing an old cable, the old cable may be removed. The shift cable 126 may be fed through the barrel adjuster 216 and the end plate 208 into the interior of the housing 200 (e.g., the interior of the second chamber of the housing 200). The shift cable 126 may be fed through the carriage 230 and pulled tight. The fixing bolt 610 may be tightened to secure the shift cable 126 to the carriage 230. The adjuster 216 may be rotated to change the tension in the shift cable 126 so that a top pulley of the rear derailleur 132 is aligned with the most outboard gear of the rear cassette 122.

Referring to FIGS. 2c and 2d, the control circuitry 232 may provide power to the motor 224. The control circuitry 232 may be electrically connected to the wire 130. Via the wire 130, the control circuitry 232 may be in communication with the controller 128 of the bicycle 100. For example, the control circuitry 232 and motor 224 may receive power from the control circuitry 128 or a battery of an e-bike via the wire 130. The wire 130 may have a connector 236 on one end. The connector 236 may provide an electrical connection between the wire 130 and the control circuitry 128 or the battery of an e-bike. In some cases, the wire 130 may be sealed where the wire enters the housing 200. For example, epoxy or another sealing material may be disposed around the wire 130 where the wire 130 enters the housing 200. The material may form a potting seal around the wire 130. The sealing prevents ingress of water into the control circuitry 232 from the outside of the housing 200. Additionally or alternatively, the sealing may reduce strain on the wire 130.

The electronic cable puller 124 may also include a rotary seal 234 to prevent ingress of water and/or debris into the control circuitry 232 from the second chamber of the housing 200. The rotary seal 234 may be located between the gearbox 226 and the advancement element 228. In some cases, where the gearbox 226 is located in a waterproof portion of the housing 200 (e.g., the first chamber of the housing 200) and the advancement element 228 is located in a user-accessible or dust proof portion of the housing 200 (e.g., the second chamber of the housing 200), the rotary seal 234 may extend between both portions of the housing 200. The rotary seal 234 may have a passage 236 through which the advancement element 228 or the gearbox 226 may extend. The passage 236 may be supported by the housing 200. The rotary seal 234 may be, for example, a stuffing box. The rotary seal 234 may include or work in conjunction with a rotary seal on the advancement element 228.

The control circuitry 232 may include one or more of a communication transceiver, an input voltage detection circuit, a voltage converter, a light emitting diode, a microcontroller, a motor controller, a Hall Effect sensor, or any combination thereof. For example, the control circuitry 232 may include two Hall Effect sensors arranged to form a quadrature encoder. The Hall Effect sensors may be arranged to correspond to the position sensor 404 of the motor 224. The communication transceiver may translate data received via the wire into data compatible with the microcontroller. For example, the communication transceiver may translate controller area network (CAN) data into serial data. The voltage converter may support one or more input voltages (or a range of input voltages) from the wire 130 and generate an output voltage to power one or more of the components of the control circuitry 232. The output voltage may be lower than the input voltage. The light emitting diode may be configured to provide user feedback and report operating errors.

The microcontroller may include one or more processors, memory, programmable inputs and outputs, timers, clocks, serial ports, analog to digital converters, digital to analog converters, pulse width modulation blocks, and interrupt controllers. The microcontroller may execute program instructions for controlling the motor 224. The motor controller may support one or more input voltages (or a range of input voltages) and be configured to power the motor 224. For example, the microcontroller may control the motor controller to operate the motor 224. In some cases, the control circuitry 232 may receive data over the wire 130. The communication transceiver may be configured to translate the received data to a format, language, or arrangement suitable for operation of the control circuitry 232. For example, the control circuitry 232 may receive a command to shift, calibrate, or perform another task with the electronic cable puller 124. The controller 128, a shift control, or another device may generate the data or command.

FIGS. 9a and 9b show perspective views of examples of the control circuitry 232 of the electronic cable puller 124. The control circuitry 232 may include a substrate 901 and one or more processors 903, antennae 905, hall effect sensors 907, communication transceivers, input voltage detection circuits, voltage converters, light emitting diodes, microcontrollers, and motor controllers. The Hall Effect sensors 907 may be disposed apart from one another. The control circuitry 232 may be disposed on a substrate 901. The substrate 901 may be a printed circuit board. Various components of the control circuitry 232 may be mounted on the substrate 901. For example, a processor 903, antenna 905, and one or more hall effect sensors 907 may be mounted on the substrate 901. Additionally or alternatively, the control circuitry 232 may include one or more attachment features 909. The attachment features 909 may be holes through the substrate 901. The attachment features 909 may attach the control circuitry 232 to the housing of the electronic cable puller 124.

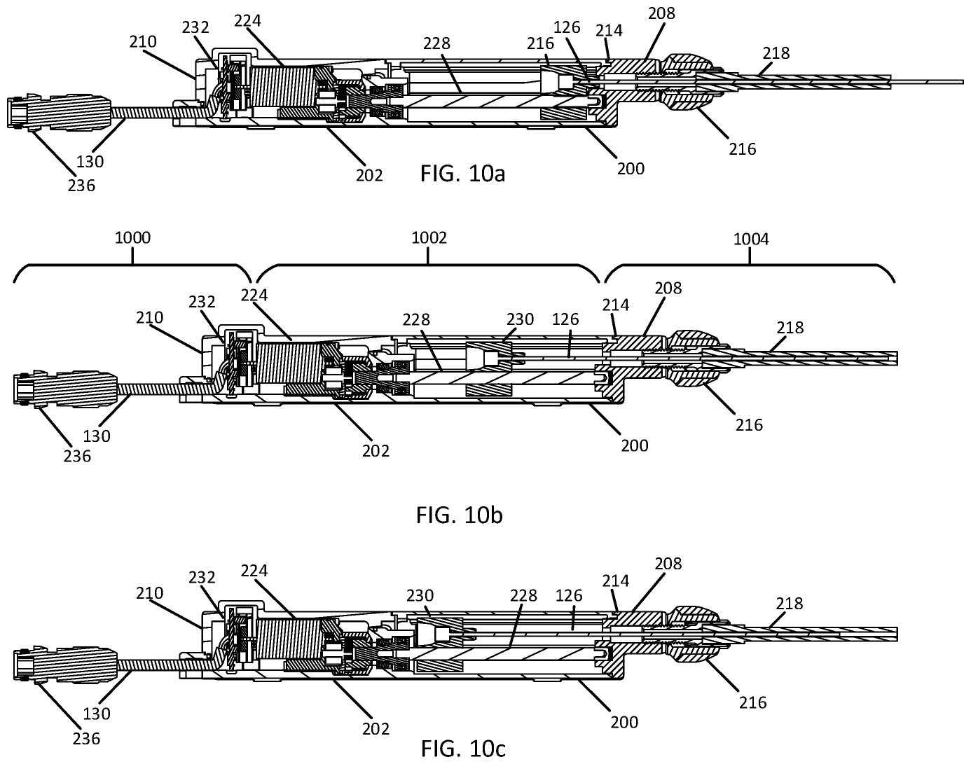

FIGS. 10a-10c show a side view of an example of an electronic cable puller (e.g., the electronic cable puller 124) with a carriage (e.g., the carriage 230) in different positions. FIG. 10a shows the carriage 230 in an extended position, FIG. 10b shows the carriage 230 in an intermediate position, and FIG. 10c shows the carriage 230 in a retracted position within the housing 200.

The electronic cable puller 124 may have a communications portion 1000, a mechanical portion 1002, and a cable attachment portion 1004. The communications portion 1000 may include the wire 130, the control circuitry 232, and the first end of the housing 210. A part of the base 202 of the housing 200 may extend into the communications portion 1000. The mechanical portion 1002 may include the motor 224, the advancement element 228, and the carriage 230. Portions of the shift cable 126 and the base 202 of the housing 200 may extend into the mechanical portion 1002. The cable attachment portion 1004 may include the end plate 208, the adjuster 216, and the second end 214 of the housing 200. Portions of the shift cable 126 and the base 202 of the housing 200 may extend into the cable attachment portion 1004. A sheath 218 of the shift cable 126 may terminate in the cable attachment portion.

Rotation of the advancement element 228 may cause the carriage 230 to translate from the extended position to the retracted position, from the retracted position to the extended position, or to or from any intermediate position between the extended position and the retracted position. The carriage 230 may translate through the mechanical portion 1002. In some cases, a distance between the extended position and the retracted position may lie in a range of 5 millimeters to 120 millimeters. For example, the distance between the positions may be 40 millimeters. Other distances may be provided.

When the carriage 230 translates in a direction toward the second end 214 of the housing 200, the shift cable 126 may be pulled out of the housing 200. For example, the rear derailleur 132 or another component may apply tension to the shift cable 126. Translation of the carriage 230 toward the second end 214 of the housing 200 may allow the rear derailleur 132 or another component to pull the shift cable 126 out of the housing 200.

When the carriage translates in a direction away from the second end 214 of the housing 200 and towards the first end 210 of the housing 200, the carriage 230 may pull the shift cable 126 into the housing 200. Tension on the shift cable 126 provided by the rear derailleur 132, the sheath 218, or another component may remove any slack in the shift cable 126 inside the housing 200.

As the carriage 230 translates from one position to another, the internal extent (e.g., a length) of the shift cable 126 inside the housing 200 may change, thereby changing an extent (e.g., a length) of the shift cable 126 outside of the housing 200. The change in the extent of the shift cable 126 outside of the housing 200 may cause the rear derailleur 132 to select or change a gear on the rear cassette 122.

The control circuitry 232 may cause the motor 224 to rotate a preset amount, resulting in a predetermined translation of the carriage 230. For example, to shift up or down a gear, the control circuitry 232 may cause the motor 224 to rotate and move the carriage 230 five millimeters closer or further from the end plate 208. In this way, a shift is executed relative to a current position of the carriage 230. The absolute position of the carriage 230 within the housing 200 may not be known at all times.

In a process known as homing, based on instructions from, for example, the controller 128, the carriage 230 may move to the extended position or the retracted position. Though a gear may be shifted relative to a current position of the carriage 230, identifying the currently selected gear may require knowing the position of the carriage 230 within the housing 200. Moving the carriage 230 to the extended position or the retracted position and monitoring the rotation of the motor 224 (e.g., using the feedback magnet 404) performed to move the carriage to either position may allow for the current position of the carriage 230 and the currently selected gear to be determined. For example, the extent of translation of the carriage 230 within the housing 200, the number of gears in the rear cassette 122, the number of rotations of the motor 224 required to cause the carriage 230 to translate from the extended position to the retracted position (or vice-versa), or the number of rotations of the motor 224 necessary to execute a gear shift, or any combination thereof may be known, while the current position of the carriage 230 may be unknown.

The carriage 230 may be homed (e.g., translated or caused to be moved by rotation of the motor 224 and the advancement element 228) to either the extended position or the retracted position, and the number of rotations or amount of rotation of the motor 224 may be measured during homing using, for example, the feedback magnet 404 and the Hall Effect sensors on the control circuitry 232. For example, the number of rotations required to home the carriage 230 divided by the total number of rotations required to cause the carriage 230 to traverse between the extended position and the retracted position may correspond to the current gear number divided the total number of gears. For example, where the number of rotations required to home the carriage 230 is half of the total rotations required for the carriage 230 to traverse between the extended position and the retracted position and where the rear cassette 122 has 12 gears, the current position of the carriage 230 may correspond to gear 7 on the rear cassette 122. In another example, where the number of rotations required to home the carriage 230 to the extended position (e.g. shown in FIG. 10a) is one twelfth of the of the total rotations, and where the rear cassette 122 has 12 gears, the current position of the carriage 230 may correspond to gear 2 on the rear cassette 122. In a further example, where the carriage 230 is already at or near the extended position or the retracted position prior to homing (e.g., the motor 224 does not rotate or rotates less than the number of rotations for a single gear change) and where the rear cassette 122 has 12 gears, the current position of the carriage 230 may correspond to gear 1 or gear 12, respectively, on the rear cassette 122. Once the currently selected gear or current position of the carriage 230 is determined by homing, the control circuitry 232 may determine a newly selected gear after a gear change by incrementing or decrementing the determined selected gear. In a further example, the position of the carriage 230 may be measured directly.

When the amount of rotation of the motor 224 required to home the carriage 230 to either the extended position or the retracted position is recorded, the carriage 230 may then be returned to a previous position by controlling the motor 224 to rotate in an opposite direction the same amount of rotation. In some cases, the motor 224 may rotate quickly so that the carriage 230 is homed and returned to a current position before the rear derailleur 132 may change a gear. In this way, the carriage 230 may be homed without changing gears.

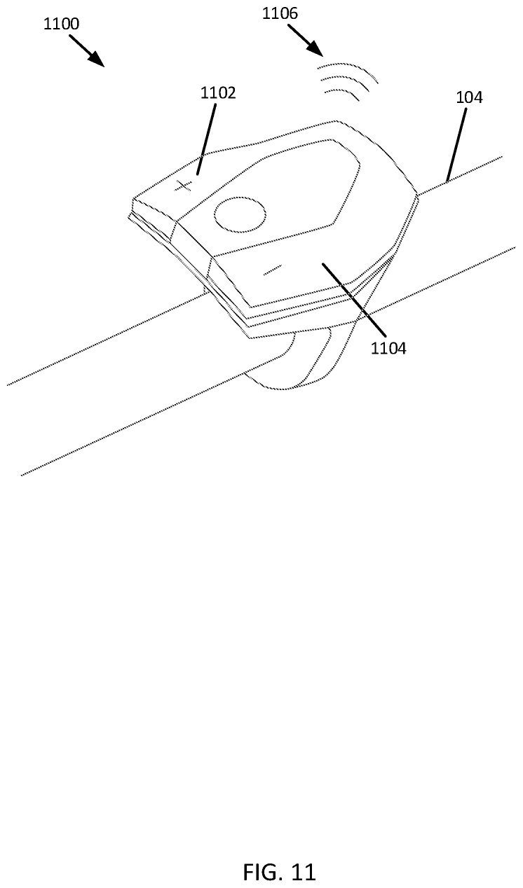

Homing may be performed in response to a signal from the e-bike controller 128. For example, the e-bike controller 128 may send a query command to the electronic cable puller 124 via the wire 130 requesting the electronic cable puller 124 return the current gear. The control circuitry 232 of the electronic cable puller may home the carriage 230, determine the current gear of the rear derailleur 132, and send a signal via the wire 130 to the controller 128 indicating the current gear. The e-bike controller 128 may receive the current gear and display the current gear. For example, the controller 128 may send a signal to display the current gear on a head unit or the shift control 1100 of FIG. 11.

FIG. 11 shows a view of a shift control 1100 for a bicycle, such as the bicycle 100 of FIG. 1. The shift control 1100 may be supported by a handlebar 104 of the bicycle 100. The shift control 1100 may include a first button 1102 and a second button 1104. A user may actuate the shift control 1100 to send a signal 1106 to the electronic cable puller 124 to change gears. For example, the user may press one of the buttons 1102, 1104 to change gears. Additionally or alternatively, the shift control 1100 may send the gear change signal 1106 to the electronic cable puller 124 without user input. For example, in response to a sensed change in terrain or heading, the shift control 1100 may automatically send a signal 1106 to the electronic cable puller 124 to change gears. In some cases, the shift control 1100 may be part of or in communication with a controller 128 of an e-bike. The shift control 1100 may send a gear change signal 1106 to the e-bike controller 128 which may send a signal to the electronic cable puller 124 via the wire 130 to change gears.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations and/or acts are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that any described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

What is claimed is:

1. An electronic cable puller for a bicycle, the electronic cable puller comprising:
a housing;
a drive supported by the housing and powerable by a power source, the drive being configured to pull a shift cable into or allow the shift cable to be pulled out of the electronic cable puller; and
an adjuster connected to the housing and configured to adjust a length of the shift cable relative to a sheath.

2. The electronic cable puller of claim 1, wherein the drive comprises:
a motor; and
a gearbox connected to the motor.

3. The electronic cable puller of claim 2, wherein the drive further comprises:
an advancement element connected to the gearbox, the motor being configured to rotate the advancement element via the gearbox.

4. The electronic cable puller of claim 3, further comprising:
the shift cable; and
a carriage disposed on the advancement element, the carriage being connected to the shift cable,
wherein the motor is configured to translate the carriage relative to the housing via the rotation of the advancement element, such that the shift cable is pulled into the housing or is allowed to be pulled out of the housing based on a direction of the translation.

5. The electronic cable puller of claim 4, wherein the housing comprises:
a base;
a first cover attached to the base, the base and the first cover defining a first end of the electronic cable puller, the first end of the electronic cable puller being opposite a second end of the cable puller; and
a second cover that is removably attached to the base and abuts or is adjacent to the first cover.

6. The electronic cable puller of claim 5, wherein the adjustor is a barrel adjuster connected to the housing at the second end of the electronic cable puller,
wherein the sheath surrounds a portion of the shift cable, and
wherein the adjuster is configured to modify a length of the sheath outside of the electronic cable puller.

7. The electronic cable puller of claim 5, wherein the base and the first cover at least partially define a first chamber, and the base and the second cover at least partially define a second chamber,
wherein the first chamber is sealed,
wherein the motor and the gearbox are disposed within the sealed first chamber,
wherein the carriage is disposed within the second chamber, and
wherein the advancement element extends between the sealed first chamber and the second chamber.

8. The electronic cable puller of claim 4, wherein the carriage comprises a body and a wing extending away from the body of the carriage, an outer profile of the wing corresponding to a channel at an inner surface of the housing.

9. The electronic cable puller of claim 8, wherein the shift cable is connected to the carriage offset relative to an axis of rotation of the advancement element.

10. The electronic cable puller of claim 4, further comprising:
a controller supported by the housing, the controller being in communication with the power source and the motor,
wherein the controller is configured to control the motor.

11. The electronic cable puller of claim 10, further comprising:
one or more sensors in communication with the controller and configured to determine a position of the carriage,
wherein the controller is configured to control the motor based on the determined position of the carriage.

12. The electronic cable puller of claim 11, wherein the one or more sensors comprise Hall effect sensors configured to determine a rotational position of the motor.

13. The electronic cable puller of claim 1, wherein the power source is external to the electronic cable puller.

14. An electronic cable puller for a bicycle, the electronic cable puller comprising:
a housing comprising:
a base;
a first cover, wherein the base and the first cover at least partially define a first chamber, the first chamber being sealed; and
a second cover removably attached to the base and abutting or adjacent to the first cover, wherein the base and the second cover at least partially define a second chamber;
a drive supported by the housing and at least partially disposed within the first chamber; and
a shift cable connected to the drive and connectable to a derailleur of the bicycle, wherein the drive is configured to pull the shift cable into or allow the shift cable to be pulled out of the electronic cable puller, such that a length of the shift cable is outside of the electronic cable puller.

15. The electronic cable puller of claim 14, wherein the drive further comprises:
a motor;
a gearbox connected to the motor; and
an advancement element connected to the gearbox, the motor being configured to rotate the advancement element via the gearbox,
wherein the electronic cable puller further comprises an internally threaded member disposed on the advancement element, the shift cable being connected to the internally threaded member, and
wherein the motor is configured to translate the internally threaded member relative to the housing via the rotation of the advancement element, such that the shift cable is pulled into the housing or is allowed to be pulled out of the housing based on a direction of the translation.

16. The electronic cable puller of claim 15, wherein the housing comprises an end plate attached to the second cover and the base,
wherein the motor and the gearbox are disposed within the sealed first chamber,
wherein the internally threaded member is disposed within the second chamber,
wherein the advancement element extends between the sealed first chamber and the second chamber.

17. The electronic cable puller of claim 14, further comprising:
a seal supported by the housing and disposed at least partially between the first chamber and the second chamber, the seal being configured to seal the first chamber from the second chamber, the advancement element extending from the first chamber, through the seal, to the second chamber.

18. The electronic cable puller of claim 14, further comprising:
a circumferential seal disposed at least partially between the first cover and the base; and
a potting seal disposed at an entry of a wire into the housing.

19. A drive system comprising:
a derailleur;
a cable; and
an electronic cable puller connected to the derailleur via the cable, the electronic cable puller comprising:
a housing;
a drive supported by the housing and connected to the cable, the drive being configured to pull the cable into the electronic cable puller or allow the cable to be pulled out of the electronic cable puller; and
an adjuster connected to the housing and configured to adjust a length of the shift cable relative to a sheath.

20. The drive system of claim 19, wherein the electronic cable puller further comprises a lead disposed at a first end of the housing, the lead being in communication with the drive, and
wherein the adjuster is connected to the housing at a second end of the housing, the second end of the housing being opposite the first end of the housing.
